(19) United States
(12) Patent Application Publication
(10) Pub. No.: US 2023/0020997 A1
(43) Pub. Date: Jan. 19, 2023

(54) SYSTEMS AND METHODS FOR USING MEDIA OBJECTS TO CREATE HIGH ENTROPY PASSWORDS

(71) Applicant: REGWEZ, INC., Newark, CA (US)

(72) Inventor: Ragy Farouk Eleish, Foster City, CA (US)

(21) Appl. No.: 17/687,526

(22) Filed: Mar. 4, 2022

Related U.S. Application Data
(60) Provisional application No. 63/156,714, filed on Mar. 4, 2021.
(60) Provisional application No. 63/156,717, filed on Mar. 4, 2021.

(51) Int. Cl. G06F 21/46

(52) U.S. Cl. CPC G06F 21/46

(57) ABSTRACT

A method comprising using at least one hardware processor to present a collection of images; receive a selection of one of these collections; and present a second screen asking a user to pick a number of the images in the selected collection.

### CROSS-REFERENCE TO RELATED APPLICATIONS

This application claims priority to U.S. Provisional Patent Application No. 63/156,714, filed on Mar. 4, 2021 and U.S. Provisional Patent Application No. 63/156,717, filed on Mar. 4, 2021, which is hereby incorporated herein by reference as if set forth in full.

### BACKGROUND

### Field of the Invention

The embodiments described herein are generally directed to high entropy passwords.

### Description of the Related Art

Theoretical password strength, also known as password entropy, is measured in bits. The total possible combinations a password can contain is computed as 2 to the power of the number of bits. For example, a numeric password of 4 digits has 10,000 theoretical combinations, so to compute its strength we use Log 2(10,000), which results in a theoretical entropy of 13 bits. The higher the password entropy is, the more resistant the password is to brute force attacks. A password entropy of 60 bits would require 60,000 years to crack using an Intel i5-6600K processor.

Alpha numeric passwords have a hard time reaching theoretical entropy levels because normal users tend to: use single case characters for speed of entry; use dictionary words for ease of memorization; and have selection bias towards some characters (7). An analysis of the passwords stolen from Yahoo in 2012 shows that most users' chosen passwords are extremely weak. For an 8 characters ASCII password composed of lower case, upper case, numbers and 21 special characters, the theoretical entropy is 51 bits (2.25E15, 95 to the power of 8). But if users use only lower-case letters, the actual entropy is 38 bits, which is 10,787 times weaker. If users use pure dictionary English words the entropy is 17 bits. A 17-bit password can be cracked in less than a second on a modern desktop machine.

To force users to use the entire character spectrum, service providers impose restrictions on the passwords they accept. For example, a password might require one upper case character, one number, and one special character. These restrictions reduce the theoretical entropy. An 8-character password using these rules would have an entropy of 50-bits, which is half the strength of the theoretical entropy. Even with these imposed restrictions, users tend to follow predictable rules. For example, they capitalize the first letter or use the number 1 and exclamation marks at the end of the password. Some users try to use simple character replacements, such as replacing the letter “o” with the number “0” or the letter “I” or “L” with an exclamation mark. For example, a user might cipher the word “welcome” to “We!c0me”. Such straightforward character substitution is known to attackers, who exploit this to more easily crack passwords.

Selection bias reduces password entropy since it increases the probability of certain characters appearing in a password, for example the exclamation mark or the number one. This allows attackers to focus on certain characters over others. An even distribution of characters in a password makes it harder for attackers to guess. A quote from a leading paper on the subject reads as follows: “Lastly, we computed the frequency distributions of password length, special character and digit use in passwords, in all four datasets. Results reveal that the majority of users are indeed selecting passwords with lengths as those suggested by password policies. However, the frequency of certain digits and special characters appearing in the passwords reveal the existence of selection bias. SETA programs need to highlight and attempt to remedy the problems of selection bias and use of publicly available information.”

The following factors determine the password strength: the number of items to select from; the number of items selected; the uniformity of frequency distributions for each item. Point 3 is very important since it controls the ability to reach the theoretical password entropy. The main limitations of direct alpha-numeric character passwords are: you have a fixed number of characters to select from; the layout of the characters is fixed, since they are in the form of a standard keyboard layout; words are easier to remember than random passwords, so users tend to use words; and numbers and special characters resembling letters are selected more frequently.

To address the first limitation, a password has to increase in length to increase its entropy, rendering it hard to remember. To address the second limitation, password rules are imposed, but they do not solve the problem as users revert to simple substitutions. Some alpha numeric based solutions have been introduced, such as Diceware. This expands the number of possible items to select from to 7776 and makes each item a dictionary word that is indexed by rolling 6 dice. A password could be: “SplashyArrestMutatePerishAloneSpecks”. These passwords are cumbersome to type and to remember. In most cases, some letters have a higher probability of selection, such as the letter “e”. This also reduces password entropy, and with it security, by increasing the selection bias.

### SUMMARY

Accordingly, systems, methods, and non-transitory computer-readable media are disclosed to using media objects to create high entropy passwords.

According to one embodiment, A method comprising using at least one hardware processor to: present a collection of images; receive a selection of one of these collections; and present a second screen asking a user to pick a number of the images in the selected collection.

Any of the methods above may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 illustrates a soft keyboard displays a set of images representing the characters of one of the natural languages, according to an embodiment;

FIG. 4 Illustrates a soft keyboard is illustrated that displays photos instead of character glyphs, where each photo is assigned a Globally Unique IDentifier (GUID), according to an embodiment;

FIG. 5 shows an image and some of the possible characteristics (tags) that can be assigned to this picture, in accordance with one embodiment;

FIG. 6 illustrates the flow from screen one to screen two, where the user selected the “fishing” collection, in accordance with one embodiment;

FIG. 7 Illustrates an alternative scenario where the user selected the Orange collection; in accordance with one example embodiment;

FIG. 8 illustrates that images A and B appear in both collections. Presenting the same item in different combinations reduces the chances of specific items being picked more than others, or certain items being repeatedly combined, in accordance with one example embodiment; and

FIG. 9A-9E illustrates a process that allows the user to select photos they can relate to and use them to quickly enter a password, according to an embodiment.

### DETAILED DESCRIPTION

In an embodiment, systems, methods, and non-transitory computer-readable media are disclosed for using media objects to create high entropy passwords.

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

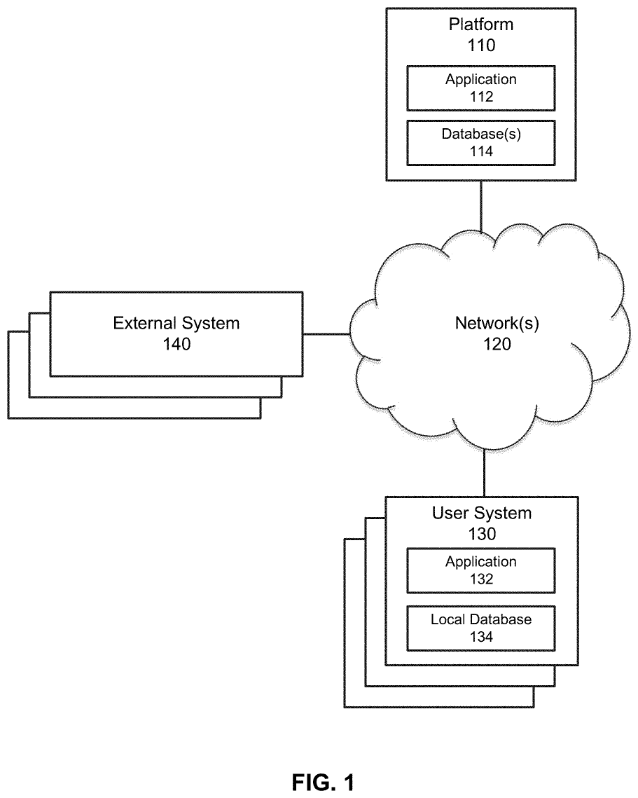

FIG. 1 illustrates an example infrastructure in which one or more of the disclosed processes may be implemented, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. Each user system 130 may comprise or be communicatively connected to a client application 132 and/or one or more local databases 134.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may comprise, be communicatively coupled with, or otherwise have access to one or more database(s) 114. For example, platform 110 may comprise one or more database servers which manage one or more databases 114. Server application 112 executing on platform 110 and/or client application 132 executing on user system 130 may submit data (e.g., user data, form data, etc.) to be stored in database(s) 114, and/or request access to data stored in database(s) 114. Any suitable database may be utilized, including without limitation MySQL™, Oracle™ IBM™, Microsoft SQL™, Access™, PostgreSQL™, MongoDB™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, executing on one or more user system(s) 130, may interact with a server application 112 executing on platform 110 to execute one or more or a portion of one or more of the various functions, processes, methods, and/or software modules described herein. In an embodiment, client application 132 may utilize a local database 134 for storing data locally on user system 130.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions described herein.

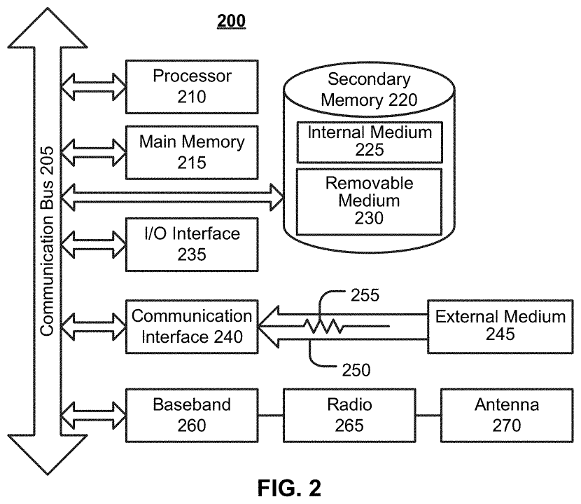

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the software) described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, any of the processors (e.g., Pentium™, Core i7™, Xeon™, etc.) available from Intel Corporation of Santa Clara, Calif., any of the processors available from Advanced Micro Devices, Incorporated (AMD) of Santa Clara, Calif., any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 preferably includes a main memory 215 and may also include a secondary memory 220. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 is a non-transitory computer-readable medium having computer-executable code (e.g., any of the software disclosed herein) and/or other data stored thereon. The computer software or data stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 include an external hard disk drive, an external optical drive, an external magneto-optical drive, and/or the like.

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed software) is stored in main memory 215 and/or secondary memory 220. Computer-executable code can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225 and/or removable medium 230), external storage medium 245, and any peripheral device communicatively coupled with communication interface 240 (including a network information server or other network device). These non-transitory computer-readable media are means for providing software and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor(s) 210. Processor(s) 210 may have access to data storage areas 215 and 220. Processor(s) 210 are preferably configured to execute instructions (i.e., computer programs, such as the disclosed software) that can be stored in main memory 215 or secondary memory 220. Computer programs can also be received from baseband processor 260 and stored in main memory 210 or in secondary memory 220, or executed upon receipt. Such computer programs, when executed, can enable system 200 to perform the various functions of the disclosed embodiments.

Embodiments of processes for using media objects to create high entropy passwords will now be described in detail. It should be understood that the described processes may be embodied in one or more software modules that are executed by one or more hardware processors (e.g., processor 210), for example, as a software application (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the software application are executed by platform 110 and other portions or modules of the software application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processor(s) 210. In addition, the disclosed software may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

The processes described below can be carried out on platform 110 or user systems 130 in order to increase password entropy for access to applications and resources on platform 110 or user systems 130. To increase password entropy without burdening the system needs to: increase the number of items users select from; and create a uniform frequency distribution for the selected items.

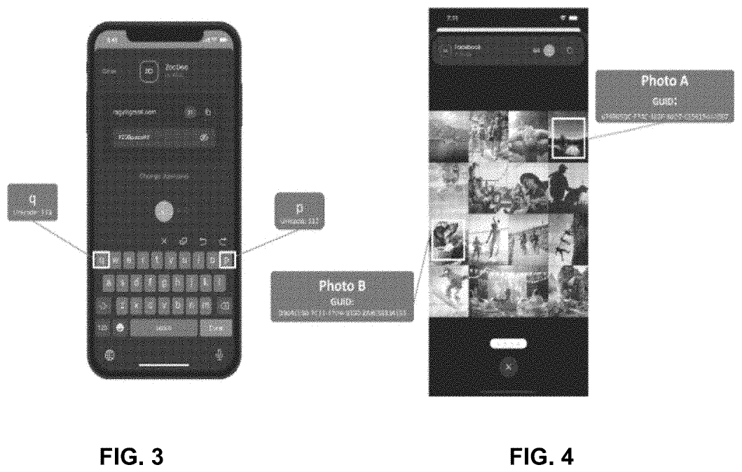

Currently, keyboards, e.g., on user system 130, are used to enter passwords. A keyboard could be a hardware keyboard that is used on desktops or laptops or a soft keyboard like the ones on smartphones. A soft keyboard displays a set of images representing the characters of one of the natural languages. These characters are arranged in a predefined manner as illustrated in FIG. 3. Each image when selected produces a well-defined code. For example, the lowercase letter “q” produces the Unicode 113, while uppercase letter “Q” produces the Unicode 81.

Thus, the systems and methods described herein are based on expanding the keyboard concept so a keyboard displays a set of visual media objects grouped in different ways. In FIG. 4 a soft keyboard is illustrated that displays photos instead of character glyphs. Each photo is assigned a Globally Unique IDentifier (GUID). By using photos instead of character glyphs, we make it easier to expand the items users select from.

The system allows users to select from a set of media object such as images, animated images, and videos. These sort of visual media objects have the following advantages: visual media objects are more likely to be remembered than words. This is known as the picture superiority effect. Also, visual media objects are virtually limitless, increasing the number of items the user can select from. This allows the theoretical password entropy to reach infinity. For example, if the number of images is 1 billion and 8 are selected then the password entropy would be 239 bits.

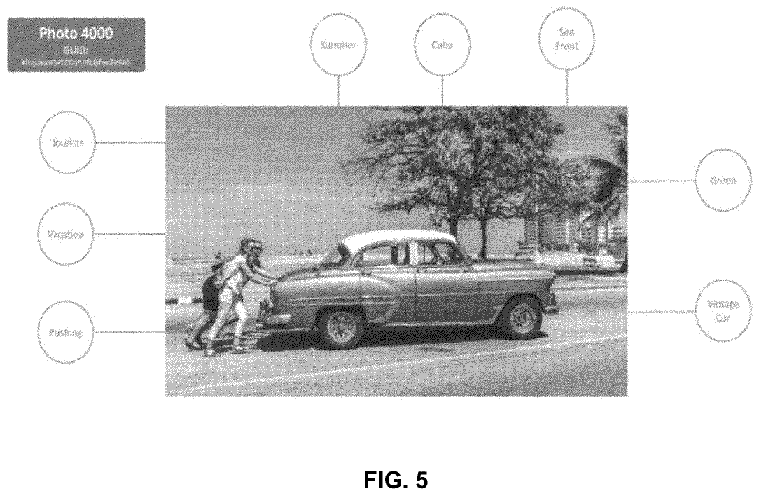

Visual media objects can have different characteristics. They can contain different subjects, color tones, locations, eras, etc. FIG. 5 shows an image and some of the possible characteristics (tags) that can be assigned to this picture. For example, a vintage car, Cuba, the act of pushing, tourists, vacation, summertime, etc. The different characteristics allow a visual media object to be present in different coherent groups, something that is hard to achieve with natural language characters such as the letter ‘g’. This creates a more uniform distribution of items in passwords, increasing their security.

In co-owned patent application Ser. No. 15/410,648, entitled “Visual Access Code’, filed Jan. 19, 2017, which is incorporated herein by reference in its entirety as if set forth in full, systems and methods are described that allows users to select hotspots in a photo in order to create a password. The systems and methods described herein expand on the systems and methods described in the this by allowing users to select a group of visual media objects from a collection of visual media objects.

This system converts a set of visual media items into an alphabet. End-users select a number of visual media items from that set. This group of visual media items is used to generate an alpha-numeric password that is compatible with existing systems. The way this works is that each photo is assigned a globally unique identifier (GUID). The globally unique identifier could be: numeric, e.g. a number from 0 to (2⁶⁴-1); textual, e.g. “2CC65800-327E-4E62-9F74-569961B5F944”; and the GUID acts like an expanded Unicode code.

For example, the end-users select a number of photos as their password from a group of photos, which is called the base set. For example:

Image1: GUID: 2CC65800-327E-4E62-9F74-569961B5F944;

Image2: GUID: D616A6EA-8D27-498B-BB4A-9FEF4C55C3A6;

Image3 GUID: 0401E035-ABAF-4E7C-BD57-100DA5B0132F; and

Image4 GUID: A17B58C4-847C-45FD-9B9F-56E19B834683.

The GUIDs of the selected photos are combined according to a deterministic algorithm to form a password for any service provider, such as a website or an encrypted hard drive. Combination algorithms can either use a simple order preserving concatenation or an order that ignores concatenation. In the example above, if the user selects image4 and image3 the password would be “A17B58C4-847C-45FD-9B9F-56E19B8346830401E035-ABAF-4E7C-BD57-100DA5B0132F” if order is respected or “0401E035-ABAF-4E7C-BD57-100DA5B0132F A17B58C4-847C-45FD-9B9F-56E19B834683” if order is not respected.

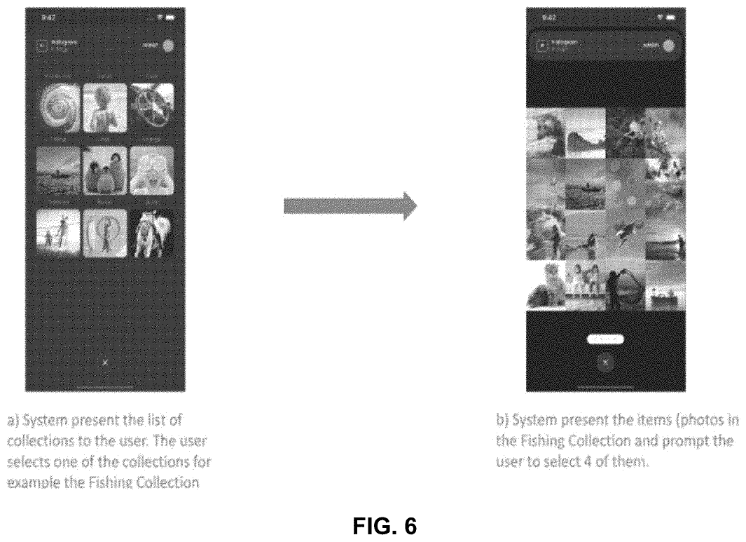

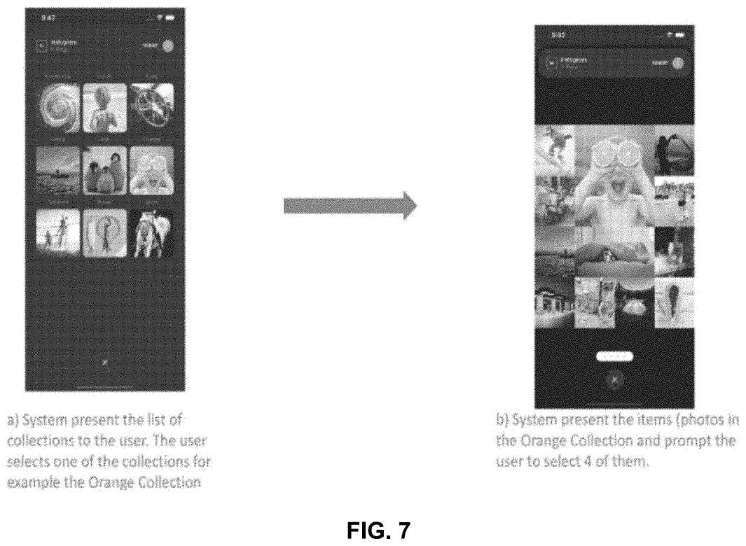

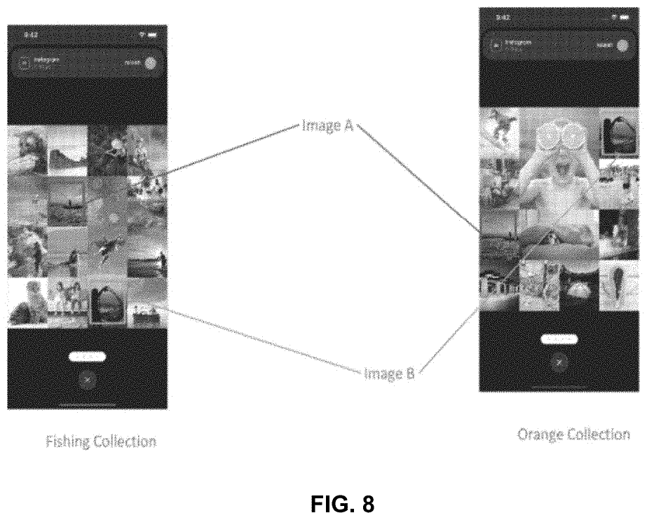

In accordance with the systems and methods described herein, users are represented with a collection of images. When they select one of these collections, they are presented with a second screen asking them to pick a number of the images in the selected collection. FIG. 6 shows the flow from screen one to screen two, where the user selected the “fishing” collection. FIG. 7 shows an alternative scenario where the user selected the Orange collection. FIG. 8 shows that images A and B appear in both collections. Presenting the same item in different combinations reduces the chances of specific items being picked more than others, or certain items being repeatedly combined. This creates a more uniform distribution, which increases the effective password entropy.

The methods and systems described herein are designed to increase the number of items users can select from, increasing the theoretical password entropy for a given number of selected items. For example, if there are 300 photos and the user select 8 photos, then the theoretical entropy is 66 bits if order is preserved and 51 if it is not. To make the practical entropy reach the theoretical entropy, we focus on evening the probability of selection for all photos in the base set. This is accomplished by doing the following: The system presents the set of possible media objects as collections, with the user selecting from one of the collections.

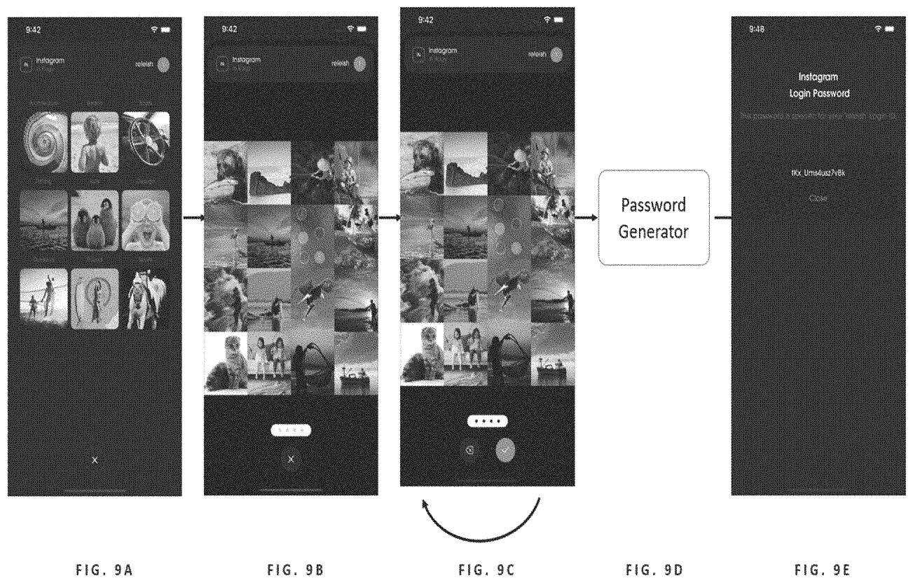

The system presents the photos in the given collection. The user selects the number of photos required. The flow shown in FIGS. 9a-e allows the user to select photos they can relate to and use them to quickly enter a password. A given photo can appear in multiple collections. FIG. 8 shows a couple of example photos that appear in two collections. Two photos appear in the Fishing and Orange collections. The purpose of presenting the same visual media object in different collections is to create an equal chance of selecting each item and so increase the entropy of the generated password as described above.

An alternative flow would allow the user to select photos from different collections. This would ultimately allow the generated password to have higher theoretical entropy.

The drawback of having a fixed photo collection is that it still reduces the practical password entropy and does not allow it to reach the highest theoretical entropy. To address this issue, the proposed system can be combined with the system described in U.S. patent application Ser. No. 15/410,660 titled “HIERARCHICAL VISUAL FACETED SEARCH ENGINE”, which is incorporated by reference herein as if disclosed in full. The combined system would enable the user to create custom media collections that are unique to them, increasing the practical entropy. This can make dealing with a large set of images humanly possible, by reducing the effort of finding photos each time a password is entered.

Another extension is to combine this system with the VISUAL ACCESS CODES of application '648 referred to above, to increase the granularity level and treat sections of an image as a character. In this combination, the user can select a full image and/or a special part of it. For example, a user can select the boy in a photo and not just the entire photo, further enhancing the entropy.

The described system could be combined with the multiple key system described in U.S. patent application Ser. No. 15/952,533, tilted “SINGLE-DEVICE MULTI-FACTOR AUTHENTICATION SYSTEM”. Where one or both of the two keys is generated using this system, it will further increase the entropy. FIGS. 9a-e shows the flow of the combined system where the photo password is used as item 5030 in the described patent. This combined system password generation process could be enhanced to generate a super password using 50 characters of Unicode. Super passwords would have 857-bit entropy, making them impossible to crack by brute force.

Thus, the systems and methods described herein use photos in a similar way to alpha numeric characters on a keyboard for the purpose of generating a password. Each image or part of an image is assigned a globally unique identifier (GUID). This identifier acts as a code similar to the Unicode character set for the purpose of entering a key. Users select a group of images or image parts. The combined GUIDs of these images act in a similar way to the characters in a traditional textual password.

Images are grouped according to a multi-dimensional tagging system, allowing a single image to appear in different collections. For example, the image in FIG. 5 could appear in the Vintage Cars, Green, Pushing, Summer, Cuba or Trouble collections. By making the same image appear in different collections we increase the probability of an image being selected, which helps to improve the theoretical entropy of the derived password.

The systems and methods described herein use a dynamic search engine to create collections of photos for the purpose of entering a password, and a two key system that uses images as the input key to generate a textual password that existing systems can accept. They can also use a SuperPassword, a 50 character long password that uses the full spectrum of the Unicode character set. This password has a theoretical entropy of 857 bits (143,696 to the power of 50). It would be virtually impossible to break this password via brute force attacks, even using future quantum computers.

Certain embodiments, allow users to specify the group of photos to select from. This will significantly increase the password entropy. The issues to address to enable this are: how to securely synchronize the photos across different devices the user owns; and how to consistently generate the same GUID for a given photo based on what it represents and not the resolution, color depth, format, crop region, etc.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
present a collection of images; receive a selection of one of these collections; and present a second screen asking a user to pick a number of the images in the selected collection.
